(19) United States
(12) Patent Application Publication
(10) Pub. No.: US 2005/0082726 A1
(43) Pub. Date: Apr. 21, 2005

(54) Ceramic components having multilayered architectures and processes for manufacturing the same

(75) Inventors: Greg E Hilmas, Rolla, MO (US); Marlene Platero, Tucson, AZ (US); Dragan Popovich, Mercer Island, WA (US); Mark J Rigali, Carlsbad, NM (US)

Correspondence Address: BANNER & WITCOFF, LTD., TEN SOUTH WACKER DRIVE, SUITE 3000, CHICAGO, IL, 60606, US

(73) Assignee: ADVANCED CERAMICS RESEARCH INC

(21) Appl. No.: 10/480,951

(22) PCT Filed: May 28, 2002
(86) PCT No.: PCT/US02/16427

Related U.S. Application Data
(60) Provisional application No. 60/293,596, filed on May 25, 2001.

(51) Int. Cl. B28B 1/00; C04B 33/32

(52) U.S. Cl. 264/612; 264/638; 264/618; 264/611; 264/615

(57) ABSTRACT

The present invention relates to multilayered ceramic components (10) and methods of fabricating such multilayered architectures. More particularly, the present invention relates to multilayered components having a plurality of dielectric (12) and electrode material (14, 15) layers. The multilayered components are manufactured by coextrusion processes.

### CROSS REFERENCE TO RELATED APPLICATIONS

This application is based on, and claims the benefit of, co-pending U.S. Provisional Application Ser. No. 60/293,596, filed on May 25, 2001, entitled “Coextrusion Melt Spinning Process for Fabricating Components Having Multilayered Architectures,” and incorporated herein by reference.

The present invention was made with U.S. Government support under grant Number DASG60-01-P-0052 awarded by the U.S. Army Space and Missile Defense and under Award Number 9660898 from the National Science Foundation. Accordingly, the U.S. Government may have certain rights in the invention described herein.

### FIELD OF THE INVENTION

The present invention relates to multilayer ceramic components, including capacitors, and methods of manufacturing such components, more particularly, coextrusion processes for manufacturing composite ceramic components having multi-layered architectures.

### BACKGROUND OF THE INVENTION

The most common method for manufacturing multi-layer ceramic capacitors (MLCCs) involves tape-casting technologies. Unfortunately, tape-casting processes pose severe handling problems as the thickness of the tape decreases. Although there has been a strong desire for a more versatile process than tape casting for fabricating MLCCs, other possible fabrication methods, such has vapor deposition techniques and sol-gel techniques, have shortcomings that have impeded their commercial success. For instance, chemical and physical vapor deposition techniques are limited by their inherently slow deposition rates. In addition, sol-gel techniques are limited because sol-gel based components must undergo large shrinkages during drying and firing.

In electronic circuitry, the demand for greater board densities and improved volumetric efficiency in components is continuously escalating. In the case of MLCCs, smaller component parts and thinner dielectric layers are required for improving the performance of electronic devices. This trend has driven the thickness of MLCC chips down from 0.120 inches in the 1980s to 0.080 inches in the late 1990s. Presently, the industry is heading towards 0.060, 0.040, and even 0.020-inch thick MLCCs. These numbers translate into dielectric layer thicknesses of approximately 20 μm in the 1980s, layer thicknesses of 13-15 μm in the mid-1990s, and less than 7.5 μm layer thicknesses in the late 1990s. The technology push worldwide has now seen the fabrication of dielectric layers of less than 5 μm and thicknesses will continue to decrease. In turn trends in manufacturing will require new methods of MLCC fabrication with more automated production for large quantities of components.

Therefore, there remains a need for a versatile method for preparing these thin film ceramic components for the electronics industry.

### SUMMARY OF THE INVENTION

It is an object of the present invention to provide methods of manufacturing electronic components having multi-layered structures, including components having layer thicknesses of 4 μm or less.

It is another object of the present invention to provide multi-layered components that include one or more dielectric material layers and one or more electrode material layers, the layers having controlled and uniform thicknesses.

It is yet another object of the present invention to provide cost-effective and efficient extrusion processes for forming multilayer components.

According to the present invention provides, a multilayer ceramic component includes alternately stacked dielectric layers and internal electrode layers. Methods of fabricating such components having multilayered architectures include combining a dielectric ceramic material with a first additive composition to form a first composite blend, combining an electrically conductive material with a second additive composition to form a second composite blend, forming a dielectric body, such as a sheet, from the first composite blend, forming an electrode body, such as a sheet, from the second composite blend, arranging a plurality of dielectric bodies and electrode bodies to form a feed rod having a patterned array of alternating dielectric and electrode layers, and extruding the feed rod to form a “green” component product having multi-layered architecture. The “green” component product then is cut into individual component pieces which are then finished. Finishing steps include a binder bake out step and a densification step to provide a fully consolidated and densified finished component product.

The finished components have improved durability and strength as compared to monolithic ceramic components. By varying the materials selected for the dielectric and electrode layers, desired mechanical strengths and electrical properties can be obtained.

### BRIEF DESCRIPTION OF THE DRAWINGS

FIG. 1 is an elevational cross-sectional view of a multilayer ceramic chip capacitor in accordance with the present invention;

FIG. 2 is a schematic block flow diagram showing a method of manufacturing a multilayer ceramic component, such as the capacitor of FIG. 1, in accordance with the present invention;

FIG. 3 is a schematic flow diagram showing steps of the method of FIG. 2; and

FIG. 4 is a top plan view of the green product FIG. 2 showing possible cut locations for forming a plurality of ceramic components from the green product.

### DETAILED DESCRIPTION OF THE INVENTION

The present invention relates to microfabrication by coextrusion processes for manufacturing multilayered ceramic components. In accordance with the present invention, it is possible to fabricate multilayered components in a wide range of sizes, including multilayered architectures with layer thicknesses of 4 μm or smaller, with uniform layers. The components have improved durability and strength as compared to monolithic ceramic components. The components also exhibit desired mechanical strengths and electrical properties, which can be modified by varying the materials used for the dielectric and electrode layers. In one embodiment, the materials used in the ceramic component are co-firable. Although the present invention provides for the fabrication of a variety of components, including multi-layered ceramic capacitors, microwave dielectric filters, multilayer piezoelectric actuators, ultrasonic motors, connectors, timing devices and energy storage devices, the invention will be described herein with reference to multilayer chip capacitors that include a plurality of dielectric ceramic and electrode layers.

As used herein, “dielectric ceramic” is intended to mean generally a nonconducting ceramic material. Such materials may be used as capacitive elements in electrical circuits and as electrical insulation. Electrical properties that may be optimized when designing such circuits typically include the dielectric constant, dielectric loss factor, and dielectric strength of the material. In general, dielectric ceramics are classified based on their permittivity. Class I dielectrics include low permittivity ceramics with dissipation factors of less than about 0.003, and medium permittivity ceramics with dissipation factors between about 15 to about 500. Dielectrics having a permittivity less than 15 are commonly referred to as insulators. Class II dielectrics include high permittivity ceramics with dissipation factors between about 2000 to about 20,000.

In an embodiment of the present invention, the critical factor is the performance of the resulting component such as a capacitor. Accordingly, the performance required for the capacitor is determined. The performance required determines what dielectric is used. Once a dielectric has been selected, an electrode is selected as a compliment to the dielectric.

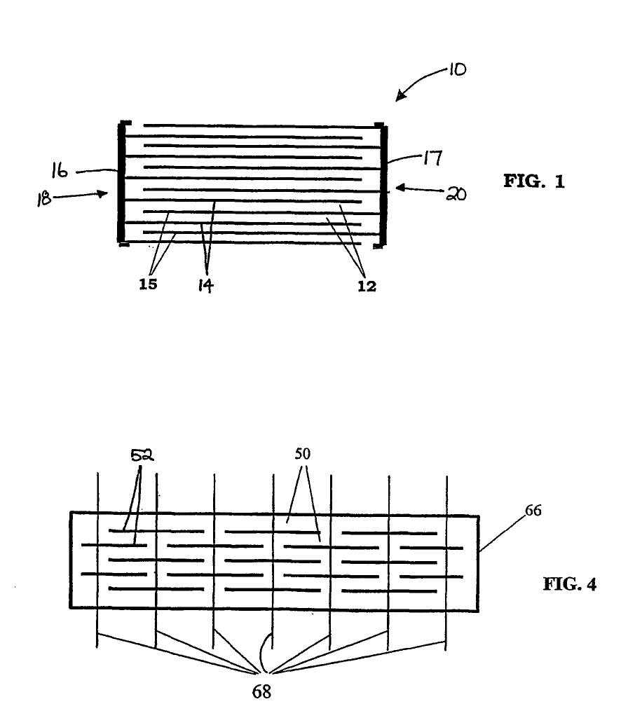

Referring to FIG. 1, there is illustrated an exemplary structure of a multilayer ceramic chip capacitor 10 (MLCC). The capacitor 10 has a plurality of alternately stacked layers of dielectric layers 12 and internal electrode layers 14, 15. External electrodes 16, 17 are disposed at side surfaces 18, 20 of the capacitor 10. The external electrodes 16 are in electrical connection with the internal electrode layers 14, 15. The internal electrode layers 14, 15 are arranged in an offset configuration so that adjacent electrodes 14, 15 extend fully to and are exposed at opposite side surfaces 18, 20. That is, one group of electrodes 14 is exposed at a first side surface 18 and is in contact with one of the external electrodes 16, and a second group of electrodes 15 is exposed at a second side surface 20 and is in contact with an external electrode 17 different from the first external electrode 16.

Although a rectangular shaped capacitor is generally described herein, components having various geometries are contemplated as being within the scope of the present invention. Additionally, the size of the component is not critical, and the component may be dimensioned according to the particular application in which it will be used. Typical dimensions range between about 0.012 inches to about 0.60 inches in length and between about 0.06 inches to about 0.54 inches in width.

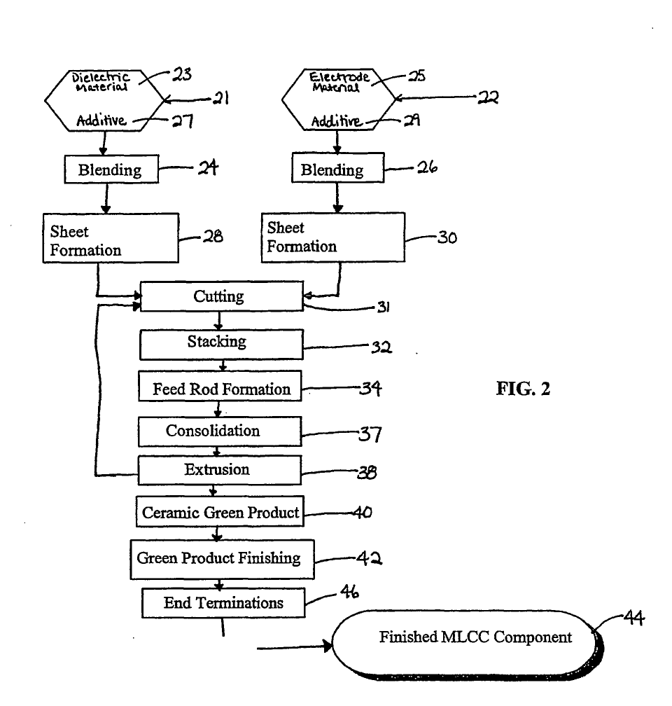

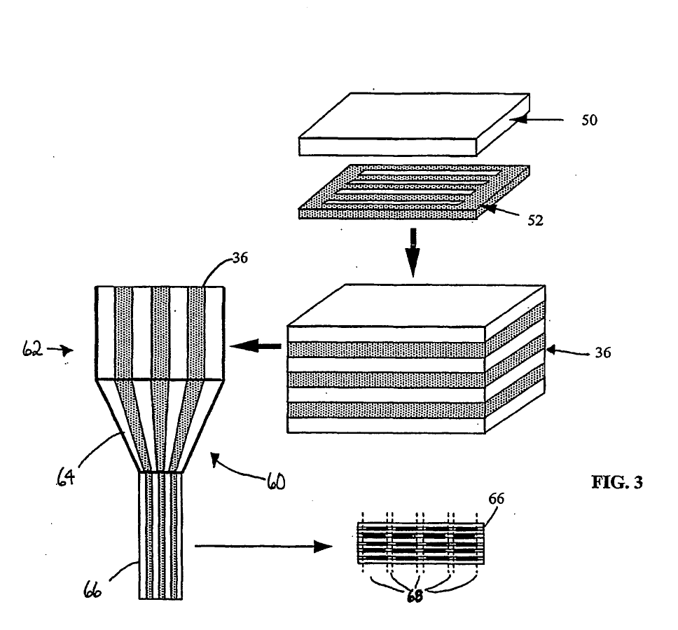

Referring now to FIGS. 2 and 3, the process of producing microlayered structures by co-extrusion in accordance with the an embodiment of the present invention includes: separately blending (as at 24) the starting materials 21 for dielectric layers, and separately blending (as at 26) the starting materials 22 for electrode layers; forming a dielectric material sheet 50 and an electrode material sheet 52 (as at 28 and 30 respectively); cutting and stacking the sheets 50, 52 (as at 31 and 32 respectively); forming a feed rod (as at 34) from the stacked sheets 50, 52; consolidating (as at 37) and extruding (as at 38) the feed rod 36 one or more times to provide a ceramic green product (as at 40); finishing the green product (as at 42); and forming end terminations (as at 44) at outer surfaces of the finished component to provide a finished product in accordance with the present invention.

Referring to FIG. 2, raw powders of dielectric material 23 and electrode material 25 are separately blended (as at 24, 26) with desired additives 27, 29 to provide composite blends. Raw powders of ferroelectric compounds may be used as the dielectric material 23. Titanate compounds, niobate compounds, tantalate compounds, any other suitable non-conductive material, and combinations thereof also may be used. Examples of suitable compounds include MgTiO₃, BaTiO₃, BaTi₄O₉, TiO₂, SrTiO₃, CaTiO₃, Al₂O₃, and MgO, and the like. Metallic powders, including base metal powders such as nickel, copper and iron, precious metal powders, other suitable conductive materials and combinations thereof may be used as the electrode material 25. Design requirements, such as interlayer thicknesses, which is identified based on application and performance requirements, should be considered when selecting the particle size of the raw powders. Generally, raw powders having particle size distributions in the range of about 0.01 to about 100 microns (μm) in size may be used. Preferably, the particle size of the powder is between about 1 to about 10 microns. The particle size of the powders selected limits the thickness of the layers of the components. That is, the layers can be only as thin as the maximum diameters of the powders used.

The raw powders may be milled in a solvent using dispersants to control the surface chemistry of the powders prior to blending 24, 26 to enhance blendability. Milling stations such as commercially available from Boston Gear, Boston, Mass. may be used as needed to ball mill the powder to obtain the desired size distribution. The ceramic/solvent blend is ball milled with milling media such as silicon nitride (Si₃N₄) or zirconium oxide (ZrO₂) thus creating a ball-mill slurry. Sintering aids such as, for example, aluminum oxide (Al₂O₃) and yttrium oxide (Y₂O₃) additions to Si₃N₄, when necessary, are added and milled together with the ball mill slurry. The powders are milled for a time effective for providing desired particle sizes and distribution. Typical milling times are between about 24 to about 120 hours, depending on the starting powder material.

The milled or, if milling is not needed, the as-received powders are mechanically blended 24, 26 to obtain desired dispersion characteristics. The blending 24, 26 may be in a high shear mixer, such as those commercially available from C.W. Brabender of South Hackensack, N.J. or from Thermo Haake of Paramus, N.J. If the powders are not milled, sintering aids, when necessary, are blended together with the raw powders during blending. Smooth, uniformly suspended dielectric and electrode composite blends are formed by the blending step 24, 26.

Additives 27, 29 may be blended with the powders during blending, as desired, to enhance the material characteristics and processability of the powder blends. Additives 27, 29 may include thermoplastic melt-spinnable polymer binders, plasticizers, waxes, and other modifiers. Examples of thermoplastic binders include ethylene ethylacetate (EEA) commercially available as DPDA-618NT from Union Carbide, ethylene vinylacetate (EVA) commercially available as ELVAX 470 from E.I. DuPont Co., and Acryloid Copolymer Resin (B-67) commercially available from Rohm and Haas, Philadelphia, Pa. Examples of plasticizers include heavy mineral oil (HMO) commercially available as Mineral Oil White, Heavy, Labguard® and methoxy polyethyleneglycol having a molecular weight of about 550 (MPEG-550) commercially available from Union Carbide. Addition of thermoplastic binders allows forming of the materials under heating conditions. The composite blends are compounded at about 150° C. while metering a viscosity-modifying additive until a viscosity is obtained that will ensure desired proper rheology for an extrusion process. The viscosities of the composite blends should be such that the blends can be pressed into sheets, can be cut through while in sheet form, can withstand repeated heating and cooling conditions, and can be co-extrudable through an orifice of predetermined geometry. Preferably, the viscosities of the dielectric and electrode composite blends are similar to one another to provide generally consistent co-extrusion of the blends.

Because the mixers have fixed volume reservoirs, the recipes for the thermoplastic/ceramic blends produced in batches are formulated on a volumetric, as opposed to a gravimetric basis. As an example, one blend consists of between about 45 to about 75 vol. % of the ceramic powder, between about 15 to about 50 vol. % of the thermoplastics, and between about 0 to about 10 vol. % of the plasticizers. Thus, the mass of a batch of ceramic/thermoplastic varies with the density of the ceramic powder.

Composite blends can be readily obtained with optimum plasticity and solid loadings in the range of 50 to 60 vol. %, or even higher loadings utilizing a bimodal particle size distribution. However, as the particle size of the powders decreases, the composite blend viscosity increases. Thus, the necessary plastic behavior is typically achieved either by lowering the solid content of the composite blend or through the addition of other organic plasticizers and modifiers to the composite blend.

By way of further example, referring also to FIG. 3, there is a schematic illustrating certain steps in the fabrication of a representative embodiment of an MLCC. The starting materials 21 and 22 are first blended 24, 26 to form dielectric and electrode composite blends. Next, the dielectric composite blend and the electrode composite blend are separately formed 28, 30 into thin dielectric bodies 50 and electrode bodies 52. Preferably, the bodies 50, 52 are formed as sheets in a heated, flat platen press (not shown). Other methods of fabricating these sheets may be utilized, such as industrial lamination presses, heated rollers, and extrusion techniques. For the fabrication of high-quality MLCCs, the thickness of the sheets may be, for example, in the range of between about 0.1 to about 0.2 mm with a variation of about ±0.01 mm. The dielectric material may be pressed to form sheets 50 having a thickness of about 1 mm, and the electrode material may be pressed to form sheets 52 having a thickness of about 0.5 mm.

Once formed, the sheets 50, 52 are cut or sectioned into strips of desired size and configuration using a slicing operation, as at 31. Other methods of sectioning, however, may be utilized, such as die stamping, water jet cutting, laser cutting, and machining for higher volume production. The sheets 50, 52 may be cut into, for example, about 1 inch by about 2 inch strips (not shown).

The cut or sectioned dielectric sheets 50 and electrode sheets 52 are next stacked (as at 32 of FIG. 2) in alternating layers to produce the offset configuration shown in FIG. 3. The sheets 50, 52 are stacked to produce a feed rod 36 predetermined dimensions and configuration. By way of example, a square feed rod having dimensions of about 2 inches long by about 1 inch wide may be formed. It should be noted that the order in which the steps of stacking and cutting the sheets 50, 52 are performed may be reversed, such that a plurality of stacked sheets 50, 52 (alternating) are cut at the same time to form strips.

The feed rod 36 is subjected to temperatures and/or pressures effective for consolidating (as at 37) the dielectric and electrode sheets 50, 52. For example, the feed rod may be consolidated at approximately 150° C. and approximately 500 pounds pressure. The feed rod 36 then is fed to an extruder 60 having an extrusion cylinder 62 fitted with a tapered extrusion block 64. A ram extruder, continuous extrusion assembly or other suitable extrusion apparatuses may be used. The dimensions and geometry of the extruder may be adjusted in accordance with the desired final product. The feed rod 36 is then extruded (as at 38, FIG. 2) into a ribbon 66. The ribbon then may be cut to form un-sintered, or “green,” MLCC chips 62 having thin, alternating dielectric and electrode layers. With reference now also to FIG. 4, the ribbon 66 may be cut at desired locations 68 to provide the MLCC chips 62. By way of example, a feed rod including BaTiO₃ as the dielectric material and Ni as the electrode material may be extruded using a 56° tapered extrusion block having about a 1 inch by about 0.1 inch final aperture. A ribbon is produced with BaTiO₃ layer thickness of about 0.1 mm and Ni layer thickness of about 0.05 mm.

The extrusion process may be repeated one or more times as desired to decrease the thickness and increase the number of the layers of the MLCC. The extruded ribbon may be cut and restacked into a second feed rod, which then may be reconsolidated and co-extruded to form an MLCC chip having thinner dielectric and electrode layers than obtained with a single-pass extrusion process. The present invention allows for the co-extrusion of even finer dielectric layers, with powder particle size being the only limitation on the ultimate layer thicknesses.

As the laminar dimensions and physical properties of the layers have a resulting effect on the performance of the products manufactured by this process, the extrusion process is controlled to produce predictable layers and properties (such as internal residual stresses). The internal surface of the extruder itself may be coated with a material, such as PTFE, in order to reduce or even eliminate the frictional effects on the lamina during extrusion. Alternatively, a thin, barrier layer (less than about 0.5 mm) of material may be positioned along the sides of the feed rod where the edges of the layers are in contact with the vertical walls of the extrusion cylinder. Such methods are intended to reduce or eliminate distortions in the resulting extrudate which otherwise may have a deleterious effect upon the properties of the finished MLCC chip.

The process as described may be used to provide green MLCC chips. As part of the finishing of the green product (as at 42), the MLCC chip is subjected to a polymer bake out cycle and a co-firing cycle (sintering cycle) in order to consolidate and densify its structure. Thermoplastic polymers are removed from the MLCC chip in a furnace heated slowly in a desired atmosphere. Design of the binder bake out cycle should consider degradation rates and temperatures of the binder system of the multilayer structure. The binder bake out cycle is preferably a slow process in order to minimize stresses and distortion in the MLCC chip during pyrolysis of the organics. If bake out occurs too rapidly, bloating, cracking, and delamination will lead to a defective chip. In addition, fine metal powders are typically excellent reaction catalysts and can catalyze the polymer decomposition reactions, also leading to part distortion. It is necessary to control the binder bake out profile and to use binders that burn out cleanly, leaving minimal residue (i.e., carbon), which can reduce the electrical properties of the devices and structures. Incomplete removal of the binder may leave the component disrupted by separation of the dielectric and electrode layers and result in areas that may cause dielectric breakdown. A binder burnout furnace, such as commercially available from Lindberg, Watertown, Wis. may be used to remove polymer binder for the polymer bake out cycle.

After removal of the binder, the MLCC chip is heated to a temperature and for a period effective for densifying the dielectric and electrode materials. Sintering occurs in a desired, preferably reducing, atmosphere, such as a nitrogen atmosphere, with only limited or no pressure being applied during the cycle. The sintering behaviors of the dielectric material and electrode material are critical to the properties of the MLCC. Large differences in the composition of the initial composite blend, as well as differing sintering characteristics between the dielectric and electrode materials, non-uniform shrinkage due to volume differences (polymer loading) and coefficient of thermal expansion mismatch can lead to significant stresses during sintering. Similar to polymer bake out, operating conditions and material characteristics may lead to delamination and cracking of the component during the co-firing cycle. Dielectric and electrode materials should be selected to avoid thermal expansion mismatch between the electrode and dielectric layers in order to limit delamination and microcracking during cooling from the sintering temperature. After final consolidation, a sintered MLCC component 44 is provided. It is expected that average layer thickness may decrease during sintering by up to about 50 vol % or more.

After polymer bake out and final consolidation, end terminations must be formed (as at 46) for the MLCC components 44. Generally, end terminations may be formed by any method know to those of skill in the art, such as by terminating the ends using Ag conductive ink. The choice of termination metal should consider cost, solderability, and leach resistance. Although many suitable metals may be used, Ag is the cheapest, most commonly used termination material.

### EXAMPLES

The following examples further illustrate embodiments of the present invention but are not be construed as in any way limiting the scope of the present invention as set forth in the appended claims.

### Example 1

Typical dielectric composite blends and electrode composite blends are set forth below in Tables 1 and 2, respectively.

TABLE 1

| Material | Density (g/cc) | Volume % |
|---|---|---|
| BaTiO₃¹ | 5.85 | 45-75 |
| EEA² | 0.93 | 15-50 |
| HMO³ | 0.881 | 0-10 |

¹BaTiO₃ powder available from TAM Ceramics, Inc. as Ticon HPB grade BaTiO₃
²Ethylene ethyl acrylate
³Heavy mineral oil

The batch size is 231 cc.

TABLE 2

| Material | Density (g/cc) | Volume % |
|---|---|---|
| Ni⁴ | 8.9 | 45-75 |
| EEA⁵ | 0.93 | 25-50 |
| B-67⁶ | 1.06 | 0-10 |
| HMO⁷ | 0.881 | 0-20 |

⁴Nickel powder (<1 μm average particle size) available from Cerac, Inc.
⁵Ethylene ethyl acrylate
⁶B-67 acryloid resin
⁷Heavy mineral oil

The batch size is 231 cc.

Barium titanate powders were purchased from TAM Ceramics, Inc. (grades Ticon TME and Ticon HPB of BaTiO3). The HPB grade has a slightly smaller particle size (D90=2.5 μm) and were used for the BaTiO3 batches in the multi-layer coextrusions. Nickel powder in the amount of 2.5 kg (less than 1 μm average) was purchased from Cerac, Inc.

### Example 2

This example illustrates a method of consolidating the “green” product (MLCC chips). The thermoplastic and plasticizer binder system (additives) is effectively removed through a bake-out period. The bake-out occurs over four days in a nitrogen atmosphere where a maximum temperature of about 600° C. is reached over the four-day cycle. The final temperature of 600° C. is reached during a ramp-up period during which the temperature is raised by about 0.1 to about 0.2° C./minute.

### Example 3

This example illustrates a method of sintering the “green” product (MLCC chips) to densify the ceramic capacitor. When BaTiO3 as the dielectric material and Ni as the electrode material, the MLCC chips initially may be co-fired in a nitrogen atmosphere at approximately 1150° C. This temperature is incrementally increased in order to obtain denser dielectric layers. The final co-firing schedule consists of a ramp of approximately 2° C./minute to approximately 1275° C. with an approximately 150 minute hold at this temperature.

While the invention has been described with respect to specifics including presently preferred modes of carrying out the invention, those skilled in the art will appreciate that there are numerous variations and permutations of the above described specific that fall within the spirit and scope of the invention as set forth in the appended claims.

1. A method of manufacturing components having multi-layer architectures comprising the steps of:
(a) combining a dielectric ceramic material with a first additive composition to form a first composite blend;
(b) combining an electrically conductive material with a second additive composition to form a second composite blend;
(c) forming a dielectric body from the first composite blend;
(d) forming an electrode body from the second composite blend;
(e) arranging a plurality of dielectric bodies and electrode bodies to form a feed rod having a patterned array of alternating dielectric and electrode layers; and
(f) extruding the feed rod to form a component product having multi-layered architecture.

2. The method of claim 1 further comprising a step of sectioning the extruded feed rod to provide a plurality of individual component products of predetermined dimensions and having multi-layered architecture.

3. The method of claim 1 wherein the patterned array of dielectric and electrode layers of the feed rod is maintained during extrusion to provide a component product having essentially the same patterned array of layers.

4. The method of claim 1 wherein the dielectric ceramic material is a ferroelectric compound.

5. The method of claim 1 wherein the dielectric material is selected from the group consisting of titanate compounds, niobate compounds tantalate compounds and combinations thereof.

6. The method of claim 1 wherein the dielectric ceramic material is selected from the group consisting of MgTiO₃, BaTiO₃, BaTi₄O₉, TiO₂, SrTiO₃, CaTiO₃, Al₂O₃, MgO and combinations thereof.

7. The method of claim 1 wherein at least one of the first and second additive compositions includes a thermoplastic binder.

8. The method of claim 1 wherein at least one of the first and second additive compositions includes a plasticizer.

9. The method of claim 1 further comprising steps of:
(a) stacking the extruded component product to form a second feed rod; and
(b) extruding the second feed rod to form a second component product having multi-layered architecture.

10. The method of claim 1 further comprising a step of heating the component product to burn out the first and second additive compositions.

11. The method of claim 10 wherein heating occurs in a nitrogen atmosphere.

12. The method of claim 1 further comprising a step of densifying the component product wherein densifying includes heating to a temperature and for a time effective for densifying the dielectric and electrode materials of the component product.

13. The method of claim 12 wherein densifying occurs in a nitrogen atmosphere.

14. The method of claim 1 wherein the step of extruding includes consolidating through the application of heat and pressure.

15. The method of claim 1 wherein the electrically conductive material is a metallic material.

16. The method of claim 15 wherein the electrically conductive material is selected from the group consisting of base metals, precious metals and combinations thereof.

17. The method of claim 1 wherein the component product includes repeated structural units having an ordered microstructure, the structural units being disposed across a working surface of the component.

18. The method of claim 1 wherein the component product is a multi-layer ceramic capacitor.

19. The method of claim 1 wherein the composite product is a microwave dielectric filter.

20. The method of claim 1 wherein the composite product is an ultrasonic motor.

21. The method of claim 1 wherein the composite product is a piezoelectric component.
